(19) United States
(12) Patent Application Publication
(10) Pub. No.: US 2024/0118520 A1
(43) Pub. Date: Apr. 11, 2024

(54) IMAGING LENS SYSTEM AND ELECTRONIC DEVICE HAVING THE SAME

(71) Applicant: SAMSUNG ELECTRONICS CO., LTD., Suwon-si (KR)

(72) Inventor: Yongsik CHO, Suwon-si (KR)

(21) Appl. No.: 18/306,676

(22) Filed: Apr. 25, 2023

(30) Foreign Application Priority Data
Oct. 6, 2022 (KR) 10-2022-0127936

(51) Int. Cl. G02B 13/00; G02B 9/64; H04N 23/55; H04N 23/57; H04N 23/68

(52) U.S. Cl. CPC G02B 13/0045; G02B 9/64; H04N 23/55; H04N 23/57; H04N 23/682

(57) ABSTRACT

An imaging lens system includes a first lens, a second lens, a third lens, a fourth lens, a fifth lens, a sixth lens, and a seventh lens, sequentially arranged from an object side of the imaging lens system to an image side of the imaging lens system, wherein a lens length (TTL) of the imaging lens system is a distance from an incident surface of the first lens to an imaging plane on the image side of the imaging lens system, wherein an image height (IH) is a diagonal diameter of an image sensor at the imaging plane on the image side of the imaging lens system, and wherein the lens length (TTL) divided by twice the image height (IH) is less than 0.56.

### CROSS-REFERENCE TO RELATED APPLICATION(S)

This application claims priority to Korean Patent Application No. 10-2022-0127936 filed on Oct. 6, 2022 in the Korean Intellectual Property Office, the disclosure of which is incorporated herein by reference in its entirety.

### BACKGROUND

The present inventive concept relates to an imaging lens system and an electronic device having the same.

Generally, a small camera may be mounted on a wireless terminal. For example, the small camera may be mounted on front and rear surfaces of the wireless terminal, respectively. Since the small camera may be used for various purposes such as outdoor landscape photography, indoor portrait photography, or the like, performance comparable to that of a general camera is required. However, it may be difficult to implement high performance in such a small camera because a mounting space thereof is limited by a size of the wireless terminal. Accordingly, there is a need to develop an optical imaging system capable of improving the performance of the small camera without increasing a size of the small camera.

### SUMMARY

An aspect of the present inventive concept is to provide an imaging lens system that improves the performance of a camera while reducing a size thereof, and an electronic device having the same.

According to an aspect of the present inventive concept, an imaging lens system includes a first lens, a second lens, a third lens, a fourth lens, a fifth lens, a sixth lens, and a seventh lens, sequentially arranged from an object side of the imaging lens system to an image side of the imaging lens system, wherein a lens length (TTL) of the imaging lens system is a distance from an incident surface of the first lens to an imaging plane on the image side of the imaging lens system, and the image height (IH) is a diagonal diameter of an image sensor on the image side of the imaging lens system.

According to an aspect of the present inventive concept, an imaging lens system includes a first lens having a convex object side surface and having positive refractive power; a second lens on an image side of the first lens, the second lens having a concave image side surface, and having negative refractive power; a third lens on an image side of the second lens, the third lens having a convex object side surface, and having positive refractive power; a fourth lens on an image side of the third lens, the fourth lens having a concave object side surface, and having negative refractive power; a fifth lens on an image side of the fourth lens, the fifth lens having a concave object side surface, and having negative refractive power; a sixth lens on an image side of the fifth lens, the sixth lens having a concave object side surface, and having negative refractive power; a seventh lens on an image side of the sixth lens, the seventh lens having a concave object side surface, having positive refractive power, and wherein the object side surface of the seventh lens and an image side surface of the seventh lens each have at least two inflection points; an eighth lens on an image side of the seventh lens, the eighth lens having a concave object side surface, and having negative refractive power; and a filter on an image side of the eighth lens, wherein a lens length (TTL) is a distance from an incident surface of the first lens to an imaging plane on the image side of the eighth lens, and wherein an image height (IH) is a diagonal diameter of an image sensor at the imaging plane on the image side of the eighth lens, and wherein the lens length (TTL) divided by twice the image height (IH) is less than 0.56.

According to an aspect of the present inventive concept, an electronic device includes a camera module having a first camera configured to capture a first image, the first camera having a first angle of view, and a second camera configured to capture a second image, the second camera having a second angle of view, narrower than the first angle of view; a memory storing software code related to a digital image stabilization module; a display device configured to display the second image captured by the second camera; an input/output interface device inputting/outputting data with an input/output device; a communication interface device communicating with an external device; and at least one processor controlling the camera module, the memory, the display device, the input/output interface device, and the communication interface device, and executing the software code, wherein at least one of the first camera and the second camera includes an imaging lens system having 7 or 8 lenses sequentially arranged from an object side of the imaging lens system to an image side of the imaging lens system, wherein a lens length (TTL) is a distance from an incident surface of a first lens in the imaging lens system to an imaging plane on the image side of the imaging lens system, and wherein an image height (IH) is a diagonal diameter of an image sensor at the imaging plane on the image side of the imaging lens system, and wherein the lens length (TTL) divided by twice the image height (IH) is less than 0.56.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a view illustrating an imaging lens system 100 according to an embodiment.

FIG. 2 is a view illustrating an imaging lens system 100a according to an embodiment.

FIG. 3 is a view illustrating an imaging lens system 100b according to another embodiment.

FIG. 4 is a view illustrating an imaging lens system 100c according to another embodiment.

FIG. 5 is a view illustrating an imaging lens system 100d according to another embodiment.

FIG. 6 is a view illustrating an electronic device 1000 according to an embodiment.

FIG. 7 is a view illustrating a camera module 1300 according to an embodiment.

FIG. 8 is a view illustrating a configuration of a camera module 1300 according to an embodiment.

FIGS. 9A and 9B are views illustrating a mobile device 2000 according to an embodiment.

### DETAILED DESCRIPTION

In the following, the content of the present inventive concept will be described clearly and in detail to the extent that a person skilled in the art could easily practice using the drawings.

An imaging lens system and an electronic device having the same according to an embodiment may form a chief ray angle (CRA) having 45° or more even while using a large image sensor, to have a lens length (TTL; a total top length) having 55% or more relative to a diagonal length of a sensor.

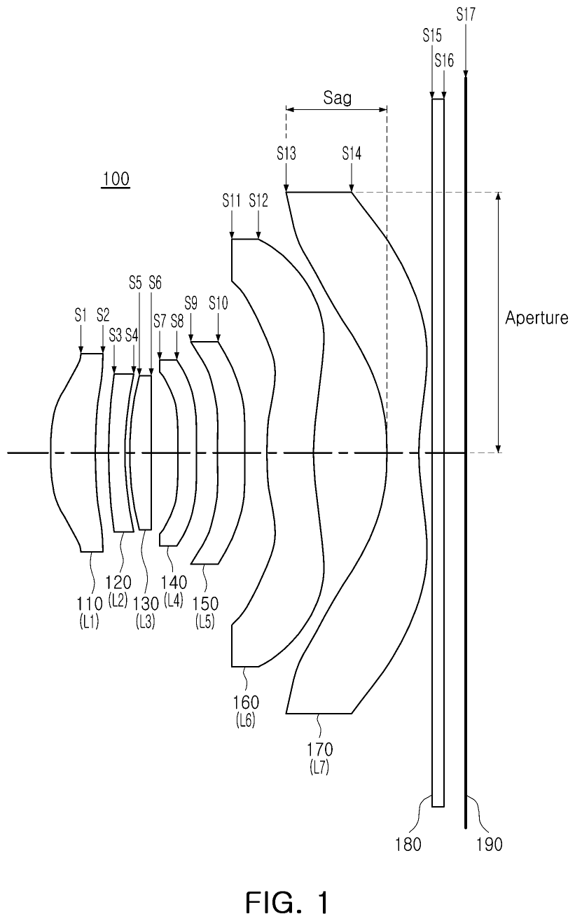

FIG. 1 is a view illustrating an imaging lens system 100 according to an embodiment. Referring to FIG. 1, an imaging lens system 100 may include a first lens 110, a second lens 120, a third lens 130, a fourth lens 140, a fifth lens 150, a sixth lens 160, a seventh lens 170, a filter 180, and an image sensor 190. In this case, the first lens 110 is a lens closest to an object (or a subject), and the seventh lens 170 is a lens closest to an image plane (or the image sensor). In addition, in description of a shape of a lens, a shape on which one surface is convex is that a paraxial region of the one surface is convex, and a shape in which one surface is concave is that a paraxial region of the one surface is concave. Therefore, even in the case that one surface of a lens is described as being convex, an edge portion of the lens may be concave. Likewise, even in the case that one surface of a lens is described as being concave, an edge portion of the lens may be convex.

The first lens 110 (L1) may have positive refractive power. An object side surface S1 of the first lens 110 may be convex, and an image side surface S2 of the first lens 110 may be concave. In an embodiment, the first lens 110 may include an aspherical surface. For example, both surfaces S1 and S2 of the first lens 110 may be aspherical. The first lens 110 may be formed of a material having high light transmittance and excellent workability. For example, the first lens 110 may be formed of a plastic material. The first lens may have a low refractive index. For example, the refractive index of the first lens may be lower than 1.6.

The second lens 120 (L2) may have negative refractive power. An object side surface S3 of the second lens 120 may be convex, and an image side surface S4 of the second lens 120 may be concave. In an embodiment, the second lens 120 may include an aspherical surface. For example, the object side surface S3 of the second lens 120 may be aspherical. The second lens 120 may be formed of a material having high light transmittance and excellent workability. For example, the second lens 120 may be formed of a plastic material. The second lens 120 may have a higher refractive index than the first lens 110. For example, the refractive index of the second lens may be 1.65 or higher.

The third lens 130 (L3) may have positive refractive power. An object side surface S5 of the third lens 130 may be convex, and an image side surface S6 of the third lens 130 may be concave. The third lens 130 may include an aspherical surface. For example, the image side surface S6 of the third lens 130 may be an aspherical surface. The third lens 130 may be formed of a material having high light transmittance and excellent workability. For example, the third lens 130 may be formed of a plastic material. In an embodiment, the third lens 130 may have a substantially similar refractive index to that of the first lens 110. For example, the refractive index of the third lens 130 may be lower than 1.6.

The fourth lens 140 (L4) may have positive refractive power. An object side surface S7 of the fourth lens 140 may be concave, and an image side surface S8 of the fourth lens 140 may be convex. In an embodiment, the fourth lens 140 may have positive/negative refractive power. The fourth lens 140 may include an aspherical surface. For example, both surfaces S7 and S8 of the fourth lens 140 may be aspherical. The fourth lens 140 may be formed of a material having high light transmittance and excellent workability. For example, the fourth lens 140 may be formed of a plastic material. In an embodiment, the fourth lens 140 may have substantially the same refractive index as the first lens 110. For example, the refractive index of the fourth lens 140 may be lower than 1.6.

The fifth lens 150 (L5) may have negative refractive power. An object side surface S9 of the fifth lens 150 may be concave, and an image side surface S10 of the fifth lens 150 may be convex. The fifth lens S150 may include an aspherical surface. For example, both surfaces S9 and S10 of the fifth lens 150 may be aspherical. The fifth lens 150 may be formed of a material having high light transmittance and excellent workability. For example, the fifth lens 150 may be formed of a plastic material. In an embodiment, the fifth lens 150 may have a higher refractive index than the fourth lens 140. For example, the refractive index of the fifth lens 150 may be 1.6 or higher.

The sixth lens 160 (L6) may have positive refractive power. An object side surface S11 of the sixth lens 160 may be convex, and an image side surface S12 of the sixth lens 160 may be concave. Also, the sixth lens 160 may have a shape in which an inflection point is formed on at least one of the object side surface S11 or the image side surface S12. In an embodiment, the sixth lens 160 may include an aspherical surface. For example, both surfaces S11 and S12 of the sixth lens 160 may be aspherical. The sixth lens 160 may be formed of a material having high light transmittance and excellent workability. For example, the sixth lens 160 may be formed of a plastic material. In an embodiment, the sixth lens 160 may have a substantially similar refractive index to that of the fifth lens 150. For example, the refractive index of the sixth lens 160 may be 1.6 or higher.

The seventh lens 170 (L7) may have negative refractive power. An object side surface S13 of the seventh lens 170 may be convex, and an image side surface S14 of the seventh lens 170 may be concave. Also, the seventh lens 170 may have a shape in which an inflection point is formed on at least one of the object side surface S13 or the image side surface S14. In an embodiment, the seventh lens 170 may include an aspherical surface. For example, both surfaces S13 and S14 of the seventh lens 170 may be aspherical. The seventh lens 170 may be formed of a material having high light transmittance and excellent workability. For example, the seventh lens 170 may be formed of a plastic material. In an embodiment, the seventh lens 170 may have a lower refractive index than the sixth lens 160. For example, the refractive index of the seventh lens 170 may be lower than 1.6.

The filter 180 may be disposed between the seventh lens 170 and the image sensor 190. The filter 180 may include an infrared radiation (IR) filter formed of optical glass and designed to remove noise generated when IR is recorded in a range of 0.8 to 14.0 μm. The filter 180 may block infrared wavelength light.

An imaging lens system 100 according to an embodiment may include a first lens 110 (L1), a second lens 120 (L2), a third lens 130 (L3), a fourth lens 140 (L4), a fifth lens 150 (L5), a sixth lens 160 (L6), and a seventh lens 170 (L7), sequentially disposed from an object side of the imaging lens system 100 to an image side of the imaging lens system 100, and a value obtained by dividing a lens length (TTL; a total top length) by twice an image height (IH) may be less than 0.56. In this case, the lens length (TTL) may be a distance from an incident surface of the first lens (L1) to the image side of the imaging lens system 100 (i.e., to an imaging plane on the image side of the imaging lens system 100 where the image sensor 190 is located), and the image height (IH) may be a diagonal diameter of the image sensor 190 at the imaging plane.

In an embodiment, each of the first lens L1 to the seventh lens L7 may be formed of a plastic material, respectively, and may include an aspherical surface, respectively. In an embodiment, a chief ray angle (CRA) of the image sensor may be greater than 40°. In an embodiment, a half field of view (HFOV) of the image sensor may be greater than 40 and less than 50. In an embodiment, a value obtained by dividing a size of an aperture through which light is incident on the first lens L1 by the image height (IH) may be greater than 0.25 and less than 0.3. In an embodiment, a flange back length (FBL) may be greater than 0.7 mm and less than 0.9 mm. In this case, FBL may be a distance from the image sensor to a lens mount. In an embodiment, a value obtained by dividing the lens length (TTL) by an effective focal length (EFL) may be greater than 1.15 and less than 1.2.

In an embodiment, an absolute value of a maximum height value (Max Sag) from an arbitrary point on an aspherical surface of the seventh lens (L7) in an optical axis direction to an apex of the aspherical surface (i.e., the aspherical surface of the seventh lens (L7), divided by a size of an effective diameter of the seventh lens (L7), may be greater than 0.25 and less than 0.45. In an embodiment, an edge of the fourth lens (L4), an edge of the fifth lens (L5), an edge of the sixth lens (L6), and an edge of the seventh lens (L7), excluding the first lens (L1), the second lens (L2) and the third lens (L3), may be implemented to be convex from the object side, respectively. In an embodiment, a value obtained by dividing a size of an effective diameter of the first lens (L1) by a size of an effective diameter of the second lens (L2) may be greater than 1.25 and less than 1.35.

An imaging lens system 100 according to an embodiment may be implemented to satisfy the following equations.

1.1<f1/EFL<1.2 [Equation 1]

In this case, f1 is a focal length of the first lens 110 from the object side. The EFL is an effective focal length of the entire optical system.

0.25<L1 Aperture/IH<0.3 [Equation 2]

In this case, the Aperture is a size (an effective diameter) through which light passes. The IH is an abbreviation for an image height, and is a half diagonal distance of an image sensor.

A refractive index of a lens (e.g., L2), secondly disposed from the object side may be 1.64 or more. At least two or more lenses having such a high refractive index may be used in the entire optical system. At least two inflection points of a lens (e.g., L6), secondly disposed from an end (an image side or a sensor side) may be on both surfaces. Both surfaces of the last lens (e.g., L7) may satisfy the following equation.

0.25<|Max Sag/Aperture|<0.45 [Equation 3]

In this case, the Sag is a value of an X coordinate when an effective diameter increases from a center of a lens (when a value of a Y coordinate increases).

The imaging lens system 100 having the above-described characteristics may satisfy the following specifications: TTL/IH*2<0.56, CRA>40, 40<HFOV<50, and 0.7<FBL<0.9. In this case, the HFOV stands for a half field of view, and is half an angle of view of the image sensor 190.

The imaging lens system 100 illustrated in FIG. 1 may be implemented with seven lenses L1 to L7, sequentially arranged from the object side. However, it should be understood that the number of lenses of the present inventive concept is not limited thereto. In some cases, the imaging lens system 100 may further include an eighth lens. In addition, all of the lenses L1 to L7 may have an aspherical surface. The aspherical surface may be expressed by the following equation.

$$\\ \begin{matrix}Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} … & [ Equation 4 ]\end{matrix}$$

Where K is a conic constant, C is a radius of curvature of a basic sphere on an optical axis (a vertex), and Y is the Aperture (an effective diameter, or a radius of the basic sphere). A to J are aspherical surface constants, and Z (or Sag) is a height from an arbitrary point on an aspherical surface in an optical axis direction to an apex of an aspherical surface corresponding thereto.

In general, a small camera is being developed in a direction in which a size of an image sensor increases for sharper and brighter pictures. As the size of the image sensor increases, a total top length (TTL) of a lens increases. A typical imaging lens system has a TTL limit of 60% relative to a diagonal length of a sensor.

An imaging lens system 100 according to an embodiment may increase a chief ray angle (CRA) up to 45° even while using a large sensor, to minimize TTL. In the imaging lens system 100 of the present inventive concept, the CRA may be formed to have 45°, it is possible to implement the TTL of 55% relative to the diagonal length of the sensor. An imaging lens system 100 according to an embodiment may reduce a relative illumination (RI), and shorten a flange back length (FBL) while minimizing the TTL. Thus, the imaging lens system 100 of the present inventive concept may minimize a change in camera module process.

Hereinafter, data of embodiments of an imaging lens system implemented to satisfy the above-described characteristics will be described.

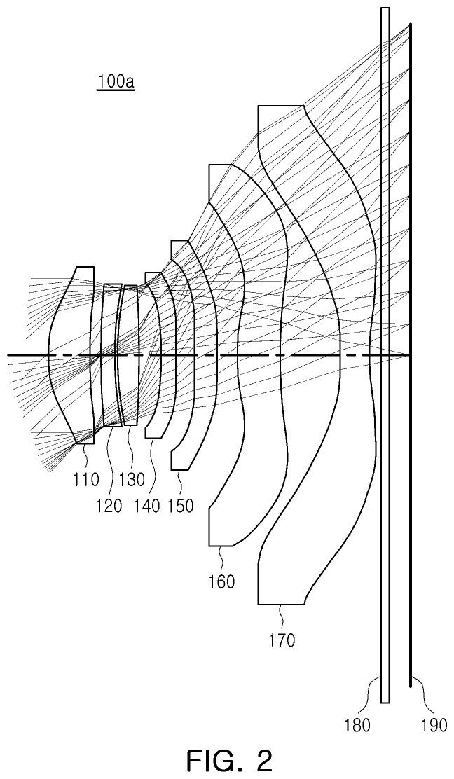

FIG. 2 is a view illustrating an imaging lens system 100a according to an embodiment. Table 1 illustrates lens data of the imaging lens system 100a illustrated in FIG. 2.

TABLE 1

| Surface | Lens | Radius | Thickness | Nd | Vd | Y Aperture | Focal Length |
|---|---|---|---|---|---|---|---|
| S1 | 1P | 2.8376359 | 0.8857527 | 1.5462742 | 55.99037 | 1.9696221 | 7.9616436 |
| S2 | | 7.264191 | 0.2707014 | | | 1.7843841 | |
| S3 | 2P | 12.146505 | 0.2767107 | 1.6775679 | 19.237429 | 1.5740662 | −25.31456 |
| S4 | | 7.0454637 | 0.0820107 | | | 1.5066207 | |
| S5 | 3P | 10.852976 | 0.4370265 | 1.5360544 | 55.655289 | 1.5018268 | 14.657332 |
| S6 | | −28.0638 | 0.5015347 | | | 1.5545303 | |
| S7 | 4P | −17.73742 | 0.33479 | 1.6775679 | 19.237429 | 1.6406002 | −28.76929 |
| S8 | | −198.4322 | 0.4123079 | | | 1.8680737 | |
| S9 | 5P | −63.15309 | 0.4947854 | 1.6195383 | 25.935966 | 2.1873615 | −85.51078 |
| S10 | | 329.76996 | 0.4162563 | | | 2.5650556 | |
| S11 | 6P | 3.7558741 | 0.9332002 | 1.5688193 | 37.724645 | 3.4406477 | 9.786659 |
| S12 | | 10.505314 | 1.3427813 | | | 4.2606163 | |
| S13 | 7P | −9.118291 | 0.6222077 | 1.5360544 | 55.655289 | 4.9890523 | −5.178946 |
| S14 | | 4.0865045 | 0.25 | | | 5.5828819 | |
| S15 | Filter | — | 0.21 | 1.5182718 | 64.197334 | 6.9515305 | — |
| S16 | | — | 0.4299345 | | | 7.0473203 | |
| Sensor | | — | 0 | | | 7.4071537 | |

In Table 1, Nd is a refractive index and Vd is Abbe's number. In this case, Abbe's number may be a numerical value of property of light dispersion of a lens, and may be used in calculation for chromatic aberration correction.

Table 2 illustrates aspheric data of the imaging lens system 100a illustrated in FIG. 2.

TABLE 2

| Sur- | | | | | | | | | | |
|---|---|---|---|---|---|---|---|---|---|---|
| face | K | A | B | C | D | E | F | G | H | J |
| S1 | −0.639019 | 0.0010149 | 0.0009606 | −0.007767 | 0.0250043 | −0.049287 | 0.0615875 | −0.05168 | 0.0301134 | −0.012365 |
| S2 | −98.98823 | 0.0355419 | −0.098652 | 0.2628481 | −0.53276 | 0.7507793 | −0.741137 | 0.5196202 | −0.26034 | 0.0927301 |
| S3 | 12.451924 | −0.003205 | −0.091394 | 0.4937084 | −1.716367 | 4.0307041 | −6.592626 | 7.7044585 | −6.526061 | 4.0171533 |
| S4 | 3.0440976 | 0.0101042 | −0.131442 | 0.8046403 | −3.256682 | 8.809862 | −16.43613 | 21.715103 | −20.62607 | 14.13583 |
| S5 | 40.008906 | 0.0008669 | 0.0996659 | −0.777877 | 3.3410794 | −9.377005 | 18.146379 | −24.86961 | 24.455958 | −17.29164 |
| S6 | −88.77732 | −0.011859 | 0.1087015 | −0.643255 | 2.4074054 | −6.085548 | 10.767505 | −13.60416 | 12.391478 | −8.136771 |
| S7 | 72.017732 | −0.004526 | −0.199275 | 0.813381 | −2.111506 | 3.7063101 | −4.558241 | 3.9946833 | −2.502655 | 1.1091852 |
| S8 | −98.99999 | −0.022144 | −0.04351 | 0.1341846 | −0.253717 | 0.3260431 | −0.30263 | 0.2098675 | −0.110669 | 0.0445173 |
| S9 | 76.561258 | −0.038587 | 0.0518535 | −0.106406 | 0.1731642 | −0.203531 | 0.170745 | −0.103339 | 0.0453875 | −0.014422 |
| S10 | −3.615307 | −0.063862 | 0.0465117 | −0.055786 | 0.0627279 | −0.053039 | 0.0321475 | −0.013934 | 0.0043213 | −0.000953 |
| S11 | −18.06293 | 0.0053961 | −0.009169 | 0.0008098 | 0.0026159 | −0.002561 | 0.0012935 | −0.000417 | 9.144E−05 | −1.4E−05 |
| S12 | −27.37021 | 0.0120024 | −0.002596 | −0.001607 | 0.0010934 | −0.000383 | 9.324E−05 | −1.65E−05 | 2.118E−06 | −1.98E−07 |
| S13 | −0.037878 | −0.037082 | 0.0089694 | −5.24E−05 | −0.000652 | 0.0002129 | −3.64E−05 | 3.959E−06 | −2.94E−07 | 1.547E−08 |
| S14 | −13.14535 | −0.025789 | 0.0084553 | −0.00269 | 0.0007096 | −0.000139 | 1.901E−05 | −1.83E−06 | 1.239E−07 | −5.97E−09 |
| S15 | 0 | 0 | 0 | 0 | 0 | 0 | 0 | 0 | 0 | 0 |
| S16 | 0 | 0 | 0 | 0 | 0 | 0 | 0 | 0 | 0 | 0 |
| S17 | 0 | 0 | 0 | 0 | 0 | 0 | 0 | 0 | 0 | 0 |

In Table 2, K is a conic constant as mentioned in Equation 4, and A to J are aspheric constants.

Table 3 illustrates optical specifications of the imaging lens system 100a illustrated in FIG. 2.

TABLE 3

| | |
|---|---|
| EFL | 6.6857208 |
| Fno | 1.95 |
| HFOV | 46.5 |
| NPmax | 1.6775679 |
| V1/N1 | 36.209858 |
| V2/N2 | 11.467451 |
| V3/N3 | 36.232628 |
| V4/N4 | 11.467451 |
| V5/N5 | 16.01442 |
| V6/N6 | 24.046521 |
| V7/N7 | 36.232628 |
| FBL | 0.75 |
| Max CRA | 44.4 |
| TTL (mm) | 7.9 |
| TTL/EFL | 1.18 |
| 2* IH (mm) | 14.3 |
| TTL/IH | 55.2% |
| TTL/EFL | 1.18 |

In Table 3, Fno is the lens number, and NPmax is the total number of parallax images.

Table 4 illustrates a focal length of each lens of the imaging lens system 100a illustrated in FIG. 2.

TABLE 4

| | |
|---|---|
| f1 | 7.9616436 |
| f2 | −25.31456 |
| f3 | 14.657332 |
| f4 | −28.76929 |
| f5 | −85.51078 |
| f6 | 9.786659 |
| f7 | −5.178946 |
| f1/f | 1.190843 |
| f2/f | −3.786362 |
| f3/f | 2.1923339 |
| f4/f | −4.303095 |
| f5/f | −12.79006 |
| f6/f | 1.4638151 |
| f7/f | −0.774628 |
| L1/L2 | 1.251 |
| L1/IH | 0.2754716 |

Table 5 illustrates an inflection point of the imaging lens system 100a illustrated in FIG. 2.

TABLE 5

| | |
|---|---|
| S1 | 1 |
| S2 | 1 |
| S3 | 0 |
| S4 | 0 |
| S5 | 0 |
| S6 | 1 |
| S7 | 0 |
| S8 | 1 |
| S9 | 1 |
| S10 | 4 |
| S11 | 3 |
| S12 | 3 |
| S13 | 3 |
| S14 | 2 |

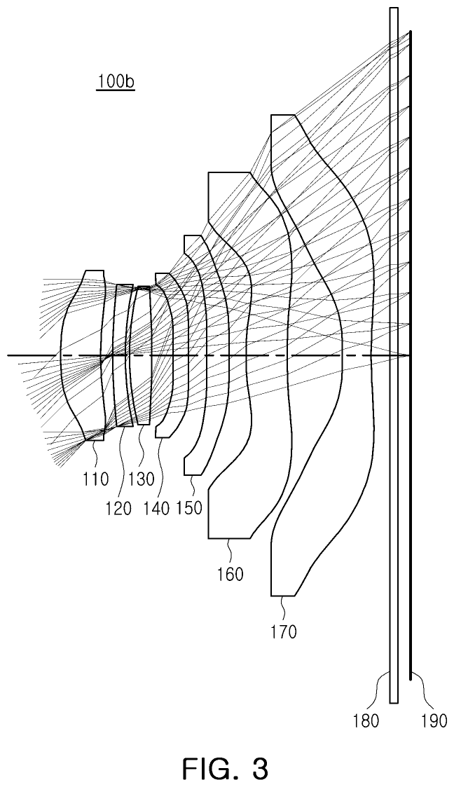

FIG. 3 is a view illustrating an imaging lens system 100b according to another embodiment. Table 6 illustrates lens data of the imaging lens system 100b illustrated in FIG. 3 as an example.

TABLE 6

| Surface | Lens | Radius | Thickness | Nd | Vd | Y Aperture | Focal Length |
|---|---|---|---|---|---|---|---|
| S1 | 1P | 2.5781334 | 0.844048 | 1.5462742 | 55.99037 | 1.7807811 | 7.2029461 |
| S2 | | 6.6126752 | 0.2456523 | | | 1.6459484 | |
| S3 | 2P | 11.053018 | 0.2505342 | 1.6775679 | 19.237429 | 1.4770971 | −22.85307 |
| S4 | | 6.3903347 | 0.0746469 | | | 1.4154205 | |
| S5 | 3P | 9.8265733 | 0.4597954 | 1.5360544 | 55.655289 | 1.4091843 | 12.641279 |
| S6 | | −21.47481 | 0.4570518 | | | 1.4524276 | |
| S7 | 4P | −18.10419 | 0.3094599 | 1.6775679 | 19.237429 | 1.4963642 | −33.86009 |
| S8 | | −86.43962 | 0.3736054 | | | 1.7230924 | |
| S9 | 5P | 1458.0693 | 0.4492558 | 1.6195383 | 25.935966 | 2.1296895 | −37.8911 |
| S10 | | 23.100305 | 0.3384352 | | | 2.5092945 | |
| S11 | 6P | 3.3119195 | 0.8552488 | 1.5688193 | 37.724645 | 2.8138874 | 8.968074 |
| S12 | | 8.5580977 | 1.1265415 | | | 3.8337446 | |
| S13 | 7P | −7.10736 | 0.5719596 | 1.5360544 | 55.655289 | 4.6577943 | −4.443323 |
| S14 | | 3.683038 | 0.4027062 | | | 5.030429 | |
| S15 | Filter | 1E+18 | 0.21 | 1.5182718 | 64.197334 | 6.5434119 | −1E+35 |
| S16 | | 1E+18 | 0.1810589 | | | 6.6365033 | |
| Si | | 1E+18 | 0 | | | 6.78 | |

Table 7 illustrates aspheric data of the imaging lens system 100b illustrated in FIG. 3.

TABLE 7

| Sur- | | | | | | | | | | |
|---|---|---|---|---|---|---|---|---|---|---|
| face | K | A | B | C | D | E | F | G | H | J |
| S1 | −1.379326 | 0.006499 | 0.0040905 | −0.036784 | 0.1240786 | −0.251911 | 0.3352205 | −0.307633 | 0.1997807 | −0.092713 |
| S2 | −97.60435 | 0.0250818 | −0.005574 | −0.15433 | 0.5925631 | −1.308681 | 1.9385214 | −2.021738 | 1.515574 | −0.820928 |
| S3 | 18.051868 | −0.038752 | 0.1849362 | −1.026143 | 3.7514389 | −9.35042 | 16.525752 | −21.16625 | 19.833504 | −13.58059 |
| S4 | 3.2009656 | −0.012768 | 0.0579329 | −0.310976 | 1.202488 | −3.015944 | 5.1233299 | −6.047351 | 5.0074823 | −2.89041 |
| S5 | 40.248991 | 0.014791 | −0.142913 | 1.0894384 | −4.909645 | 14.538321 | −29.63343 | 42.757979 | −44.31679 | 33.094484 |
| S6 | −0.775364 | 0.000124 | −0.014473 | 0.1710123 | −1.009981 | 3.7045205 | −8.883762 | 14.496559 | −16.48979 | 13.206644 |
| S7 | 7.204638 | −0.026495 | −0.137482 | 0.8338689 | −3.353087 | 9.1138977 | −17.35205 | 23.652436 | −23.34028 | 16.689122 |
| S8 | 99 | −0.027237 | −0.07033 | 0.3099805 | −0.883387 | 1.692049 | −2.273641 | 2.1949535 | −1.540206 | 0.7864427 |
| S9 | 0.0050009 | −0.03694 | 0.0203738 | 0.0020267 | −0.037019 | 0.0638623 | −0.066045 | 0.0466874 | −0.023408 | 0.0084415 |
| S10 | 0.2634954 | −0.084821 | 0.0404662 | −0.003229 | −0.02823 | 0.039697 | −0.03092 | 0.0158943 | −0.005648 | 0.0014094 |
| S11 | −18.1737 | 0.0035269 | −0.035975 | 0.0409621 | −0.037501 | 0.0249534 | −0.011992 | 0.0041878 | −0.001071 | 0.0002008 |
| S12 | −26.53096 | 0.0122442 | −0.010442 | 0.0032095 | −0.000668 | 9.119E−05 | −6.14E−06 | −1.11E−08 | −3.51E−08 | 2.193E−08 |
| S13 | 0.0006012 | −0.062844 | 0.0198016 | −0.001569 | −0.001391 | 0.0007125 | −0.000174 | 2.636E−05 | −2.67E−06 | 1.871E−07 |
| S14 | −13.11515 | −0.048185 | 0.0209428 | −0.007947 | 0.002364 | −0.000519 | 8.189E−05 | −9.26E−06 | 7.528E−07 | −4.4E−08 |
| S15 | 0 | 0 | 0 | 0 | 0 | 0 | 0 | 0 | 0 | 0 |
| S16 | 0 | 0 | 0 | 0 | 0 | 0 | 0 | 0 | 0 | 0 |
| S17 | 0 | 0 | 0 | 0 | 0 | 0 | 0 | 0 | 0 | 0 |

Table 8 illustrates optical specifications of the imaging lens system 100b illustrated in FIG. 3.

TABLE 8

| | |
|---|---|
| EFL (mm) | 6.1 |
| Fno | 1.9 |
| HFOV | 46.378623 |
| NPmax | 1.6775679 |
| V1/N1 | 36.209858 |
| V2/N2 | 11.467451 |
| V3/N3 | 36.232628 |
| V4/N4 | 11.467451 |
| V5/N5 | 16.01442 |
| V6/N6 | 24.046521 |
| V7/N7 | 36.232628 |
| FBL | 0.75 |
| Max CRA | 44.4 |
| TTL (mm) | 7.15 |
| TTL/EFL | 1.17 |
| 2*IH (mm) | 13.096 |
| TTL/IH | 54.6% |
| TTL/EFL | 1.17 |

Table 9 illustrates a focal length of each lens of the imaging lens system 100b illustrated in FIG. 3.

TABLE 9

| | |
|---|---|
| f1 | 7.2029461 |
| f2 | −22.85307 |
| f3 | 12.641279 |
| f4 | −33.86009 |
| f5 | −37.8911 |
| f6 | 8.968074 |
| f7 | −4.443323 |
| f1/f | 1.1808108 |
| f2/f | −3.746406 |
| f3/f | 2.0723409 |
| f4/f | −5.550835 |
| f5/f | −6.211656 |
| f6/f | 1.4701761 |
| f7/f | −0.728414 |
| L1/L2 | 1.206 |
| L1/IH | 0.271958 |

Table 10 illustrates an inflection point of the imaging lens system 100b illustrated in FIG. 3.

TABLE 10

| | |
|---|---|
| S1 | 1 |
| S2 | 1 |
| S3 | 0 |
| S4 | 0 |
| S5 | 0 |
| S6 | 1 |
| S7 | 0 |
| S8 | 1 |
| S9 | 1 |
| S10 | 4 |
| S11 | 3 |
| S12 | 3 |
| S13 | 3 |
| S14 | 2 |

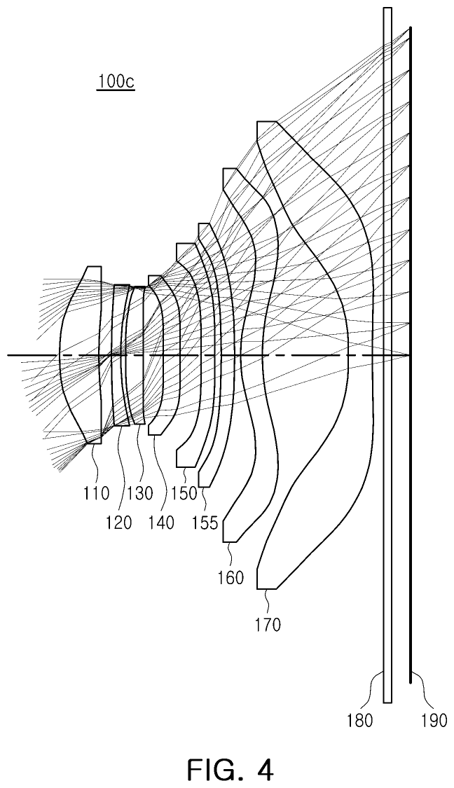

FIG. 4 is a view illustrating an imaging lens system 100c according to another embodiment. Table 11 illustrates lens data of the imaging lens system 100c illustrated in FIG. 4.

TABLE 11

| Surface | Lens | Radius | Thickness | Nd | Vd | Y Aperture | Focal Length |
|---|---|---|---|---|---|---|---|
| S1 | 1P | 3.2259672 | 0.9933978 | 1.5462742 | 55.99037 | 2.3053622 | 8.535329 |
| S2 | | 38.080827 | 0.3286956 | | | 2.1597482 | |
| S3 | 2P | 18.370784 | 0.2501188 | 1.6775679 | 19.237429 | 1.807935 | −20.87246 |
| S4 | | 7.9469108 | 0.1014706 | | | 1.7616339 | |
| S5 | 3P | 11.850611 | 0.4549987 | 1.5360544 | 55.655289 | 1.7682967 | 20.229872 |
| S6 | | 23.173201 | 0.5033421 | | | 1.791608 | |
| S7 | 4P | −4.706013 | 0.4331092 | 1.6402309 | 23.900901 | 1.8262555 | −105.2239 |
| S8 | | −4.313323 | 0.4996875 | | | 2.0342876 | |
| S9 | 5P | 27.56953 | 0.3300011 | 1.6195383 | 25.935966 | 2.4431663 | −32.13435 |
| S10 | | −9.052525 | 0.1885627 | | | 2.8902291 | |
| S11 | 6P | −11.29061 | 0.3301285 | 1.6195383 | 25.935966 | 3.0722247 | 1390.1081 |
| S12 | | −11.26916 | 0.1303563 | | | 3.3820915 | |
| S13 | 7P | 2.6831476 | 0.5556731 | 1.5360544 | 55.655289 | 4.3369996 | 9.9086798 |
| S14 | | 5.0302622 | 2.1884995 | | | 4.7771826 | |
| S15 | 8P | −8.94853 | 0.5500005 | 1.5688193 | 37.724645 | 5.5691461 | −5.730152 |
| S16 | | 5.241069 | 0.2987469 | | | 5.9890867 | |
| S17 | Filter | 1E+18 | 0.21 | 1.5182718 | 64.197334 | 7.9625209 | −1E+35 |
| S18 | | 1E+18 | 0.4833109 | | | 8.0523714 | |
| Si | | 1E+18 | −0.029999 | | | 8.4025516 | |

Table 12 illustrates aspheric data of the imaging lens system 100c illustrated in FIG. 4.

TABLE 12

| Sur- | | | | | | | | | | |
|---|---|---|---|---|---|---|---|---|---|---|
| face | K | A | B | C | D | E | F | G | H | J |
| S1 | −1.235263 | 0.004427 | −0.006794 | 0.0190694 | −0.036384 | 0.0459439 | −0.039553 | 0.023761 | −0.010118 | 0.0030702 |
| S2 | 0 | −0.005046 | −0.012711 | 0.0469468 | −0.104001 | 0.1462983 | −0.138507 | 0.0915057 | −0.043029 | 0.0144918 |
| S3 | −47.02843 | −0.010773 | 0.002208 | 0.0269091 | −0.125228 | 0.3000362 | −0.447046 | 0.4468179 | −0.310613 | 0.1523266 |
| S4 | 6.3462738 | −0.004436 | 0.0021088 | −0.00701 | 0.0289215 | −0.062238 | 0.0870669 | −0.084509 | 0.0583085 | −0.0288 |
| S5 | 39.547578 | 0.0021318 | 0.0096944 | −0.073811 | 0.2549742 | −0.534433 | 0.7433522 | −0.71731 | 0.4915857 | −0.241202 |
| S6 | 0 | −0.008259 | 0.0463336 | −0.167509 | 0.3982774 | −0.647148 | 0.7437365 | −0.616131 | 0.3710661 | −0.162185 |
| S7 | 0 | −0.018554 | −0.010443 | 0.0188251 | 0.0025345 | −0.090207 | 0.2032552 | −0.248801 | 0.1971725 | −0.106858 |
| S8 | 0 | −0.02043 | −0.002595 | 0.0200904 | −0.065192 | 0.1158457 | −0.133038 | 0.1045224 | −0.057641 | 0.0225022 |
| S9 | 0 | −0.037209 | 0.0016618 | 0.0389711 | −0.070728 | 0.0733287 | −0.052267 | 0.0269629 | −0.010227 | 0.0028503 |
| S10 | 0 | −0.041763 | 0.0068733 | 0.0101873 | −0.019083 | 0.0160549 | −0.008538 | 0.0031754 | −0.000853 | 0.0001661 |
| S11 | 9.6706716 | 0.044422 | −0.029053 | 0.0067134 | 0.0029162 | −0.00441 | 0.0026672 | −0.000984 | 0.0002412 | −4.07E−05 |
| S12 | 1.215564 | 0.0007438 | 0.0081551 | −0.01264 | 0.0103367 | −0.005503 | 0.0020042 | −0.000511 | 9.227E−05 | −1.19E−05 |
| S13 | −11.53444 | 0.0146445 | −0.011591 | 0.0029794 | 2.729E−05 | −0.000261 | 8.806E−05 | −1.62E−05 | 1.938E−06 | −1.56E−07 |
| S14 | −23.32101 | 0.0250437 | −0.011797 | 0.0018351 | 0.0003977 | −0.000281 | 7.371E−05 | −1.18E−05 | 1.292E−06 | −9.88E−08 |
| S15 | −0.388378 | −0.045118 | 0.0220331 | −0.008429 | 0.0022248 | −0.000408 | 5.317E−05 | −4.97E−06 | 3.345E−07 | −1.62E−08 |
| S16 | −41.20664 | 0.022521 | 0.0091499 | −0.002753 | 0.0005597 | −8.01E−05 | 8.304E−06 | −6.32E−07 | 3.538E−08 | −1.45E−09 |

Table 13 illustrates optical specifications of the imaging lens system 100c illustrated in FIG. 4.

TABLE 13

| | |
|---|---|
| EFL | 7.7056185 |
| Fno | 1.95 |
| HFOV | 46.105066 |
| NPmax | 1.6775679 |
| V1/N1 | 36.209858 |
| V2/N2 | 11.467451 |
| V3/N3 | 36.232628 |
| V4/N4 | 14.571669 |
| V5/N5 | 16.01442 |
| V6/N6 | 16.01442 |
| V7/N7 | 36.232628 |
| V8/N8 | 24.046521 |
| FBL | 0.85 |
| Max CRA | 42.2 |
| TTL (mm) | 8.8 |
| TTL/EFL | 1.14 |
| 2*IH (mm) | 16.332 |
| TTL/IH | 53.9% |
| TTL/EFL | 1.14 |

Table 14 illustrates a focal length of each lens of the imaging lens system 100c illustrated in FIG. 4.

TABLE 14

| | |
|---|---|
| f1 | 8.535329 |
| f2 | −20.87246 |
| f3 | 20.229871 |
| f4 | −105.224 |
| f5 | −32.13435 |
| f6 | 1390.1081 |
| f7 | 9.9086798 |
| f8 | −5.730152 |
| f1/f | 1.107676 |
| f2/f | −2.708732 |
| f3/f | 2.6253403 |
| f4/f | −13.65549 |
| f5/f | −4.17025 |
| f6/f | 180.40188 |
| f7/f | 1.2859032 |
| f8/f | −0.743633 |
| L1/IH | 0.2823123 |
| L1/L2 | 1.275 |

Table 15 illustrates an inflection point of the imaging lens system 100c illustrated in FIG. 4.

TABLE 15

| | |
|---|---|
| S1 | 1 |
| S2 | 1 |
| S3 | 0 |
| S4 | 0 |
| S5 | 0 |
| S6 | 1 |
| S7 | 1 |
| S8 | 1 |
| S9 | 3 |
| S10 | 3 |
| S11 | 3 |
| S12 | 1 |
| S13 | 2 |
| S14 | 4 |
| S15 | 7 |
| S16 | 4 |

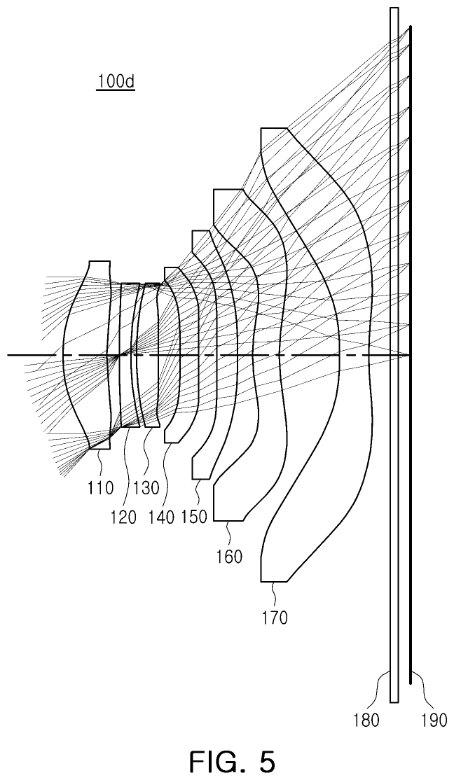

FIG. 5 is a view illustrating an imaging lens system 100d according to another embodiment. Referring to FIG. 5, a first lens 110 may be convex toward an object side of the imaging lens system 100d (i.e., the side of the imaging lens system 100d where the object is located), may have positive refractive power, may satisfy 1.1<f1/EFL<1.2, may have an aperture greater than 0.25 and less than 0.3 of IH, and may have a size of 1.25 times or more and 1.35 times or less than that of a second lens 120. In this case, positive refractive power may be obtained when f1>0, and negative refractive power may be obtained when f1<0. The second lens 120 may have negative refractive power, an image side surface of the second lens 120 may be concave, and the second lens 120 may have a refractive index of 1.65 or more (characteristic of a material). At least, two or more sheets (i.e., lenses) in an optical system may have a refractive index of 1.65 or more. A third lens 130 may have a convex object side surface, and may have positive refractive power. A fourth lens 140 and a fifth lens 150 may have concave object side surfaces, and may have negative refractive power. A sixth lens 160 may have a concave object side surface, may have positive refractive power, and may have a meniscus shape forming at least two inflection points on both surfaces. In this case, the meniscus shape is a shape in which both surfaces are bent in the same direction. A seventh lens 170 may have a concave object side surface, may have negative refractive power, and may satisfy 0.25<|Max Sag/Aperture|<0.45 condition.

In addition, an edge of each of the lenses 140, 150, 160, and 170, excluding the first lens 110, the second lens 120, and the third lens 130, may be convex toward the object side of the imaging lens system 100d. The optical system 100b described above may satisfy conditions of CRA>40, 40<HFOV<50, and 0.7<FBL<0.9, and may finally satisfy TTL/*2)<0.6.

Table 16 illustrates lens data of the imaging lens system 100d illustrated in FIG. 5.

TABLE 16

| Surface | Lens | Radius | Thickness | Nd | Vd | Y Aperture | Focal Length |
|---|---|---|---|---|---|---|---|
| S1 | 1P | 2.5177113 | 0.876641 | 1.5462742 | 55.99037 | 1.8286463 | 6.9603917 |
| S2 | | 6.5356199 | 0.2353692 | | | 1.6640601 | |
| S3 | 2P | 10.795943 | 0.2501525 | 1.6775679 | 19.237429 | 1.4041132 | −21.55524 |
| S4 | | 6.1493674 | 0.0691348 | | | 1.3680029 | |
| S5 | 3P | 9.216714 | 0.4434318 | 1.5360544 | 55.655289 | 1.3710375 | 12.092664 |
| S6 | | −21.48291 | 0.4215313 | | | 1.4122192 | |
| S7 | 4P | −17.99259 | 0.38365 | 1.6670803 | 20.347277 | 1.4766361 | −26.96463 |
| S8 | | −3.709524 | 0.3357299 | | | 1.7242126 | |
| S9 | 5P | 26.736687 | 0.3881539 | 1.6402309 | 23.900901 | 2.0489159 | −67.61103 |
| S10 | | 16.434286 | 0.2839342 | | | 2.4376112 | |
| S11 | 6P | 2.6570108 | 0.5446588 | 1.5916651 | 28.268691 | 2.5851801 | 8.9355683 |
| S12 | | 4.9344396 | 1.1850093 | | | 3.2602298 | |
| S13 | 7P | −6.845261 | 0.5509849 | 1.5360544 | 55.655289 | 4.1478092 | −4.491803 |
| S14 | | 3.8187501 | 0.3988541 | | | 4.6035375 | |
| S15 | Filter | 1E+18 | 0.21 | 1.5182718 | 64.197334 | 10.819623 | −1E+35 |
| S16 | | 1E+18 | 0.2227642 | | | 10.983206 | |
| Si | | 1E+18 | 0 | | | 11.560807 | |

Table 17 illustrates aspheric data of the imaging lens system 100d illustrated in FIG. 5.

TABLE 17

| Sur- | | | | | | | | | | |
|---|---|---|---|---|---|---|---|---|---|---|
| face | K | A | B | C | D | E | F | G | H | J |
| S1 | −1.418596 | 0.0131723 | −0.049995 | 0.2047352 | −0.537626 | 0.9415788 | −1.147436 | 0.9957306 | −0.622736 | 0.281124 |
| S2 | −98.42987 | 0.0296849 | −0.073687 | 0.1820319 | −0.49272 | 1.0171745 | −1.495552 | 1.5706458 | −1.188833 | 0.6495435 |
| S3 | −2.764364 | −0.03624 | 0.1065901 | −0.684223 | 3.024164 | −9.385672 | 20.865469 | −33.29444 | 38.14368 | −31.27467 |
| S4 | −0.885419 | 0.0014533 | −0.098168 | 0.8494229 | −4.696341 | 16.860673 | −40.67323 | 68.14596 | −80.85392 | 68.3714 |
| S5 | 39.755732 | 0.0127594 | 0.0584858 | −0.745867 | 4.1291402 | −13.89936 | 31.208296 | −48.84382 | 54.505062 | −43.69013 |
| S6 | −74.58863 | −0.003625 | 0.0421737 | −0.314757 | 1.7111802 | −6.211501 | 15.38985 | −26.58561 | 32.479974 | −28.18358 |
| S7 | 12.331438 | −0.038585 | −0.049701 | 0.3889499 | −1.83246 | 5.6374359 | −11.90294 | 17.728573 | −18.90946 | 14.498491 |
| S8 | 0 | −0.04243 | −0.013499 | 0.0596776 | −0.147789 | 0.264507 | −0.375727 | 0.4153214 | −0.345096 | 0.2100974 |
| S9 | 97.734747 | −0.043767 | 0.0189625 | −0.027826 | 0.1030824 | −0.227826 | 0.3017765 | −0.264773 | 0.1611707 | −0.069232 |
| S10 | −23.42416 | −0.101565 | 0.0558235 | −0.055895 | 0.1043327 | −0.146458 | 0.1341486 | −0.083147 | 0.0358547 | −0.010866 |
| S11 | −18.06951 | 0.0510782 | −0.124666 | 0.1295293 | −0.115914 | 0.0882157 | −0.054216 | 0.0254782 | −0.008841 | 0.002215 |
| S12 | −41.41534 | 0.0634406 | −0.060714 | 0.0195203 | 0.0051521 | −0.009036 | 0.0050097 | −0.001695 | 0.0003901 | −6.31E−05 |
| S13 | 0.0512695 | −0.077531 | 0.0518121 | −0.030921 | 0.0135608 | −0.003844 | 0.0006905 | −7.63E−05 | 4.392E−06 | 2.369E−08 |
| S14 | −23.05852 | −0.046528 | 0.0232623 | −0.009072 | 0.0022019 | −0.000291 | 7.748E−06 | 4.407E−06 | −9.09E−07 | 9.661E−08 |
| S15 | 0 | 0 | 0 | 0 | 0 | 0 | 0 | 0 | 0 | 0 |
| S16 | 0 | 0 | 0 | 0 | 0 | 0 | 0 | 0 | 0 | 0 |
| S17 | 0 | 0 | 0 | 0 | 0 | 0 | 0 | 0 | 0 | 0 |

Table 18 illustrates optical specifications of the imaging lens system 100d illustrated in FIG. 5.

TABLE 18

| | |
|---|---|
| EFL | 5.8550914 |
| Fno | 1.9 |
| HFOV | 45.658282 |
| NPmax | 1.6775679 |
| V1/N1 | 36.209858 |
| V2/N2 | 11.467451 |
| V3/N3 | 36.232628 |
| V4/N4 | 12.205337 |
| V5/N5 | 14.571669 |
| V6/N6 | 17.760451 |
| V7/N7 | 36.232628 |
| FBL | 0.75 |
| Max CRA | 45.3 |
| TTL (mm) | 6.8 |
| TTL/EFL | 1.16 |
| 2*IH (mm) | 12.258 |
| TTL/IH | 55.5% |
| TTL/EFL | 1.16 |

Table 19 illustrates a focal length of each lens of the imaging lens system 100d illustrated in FIG. 5.

TABLE 19

| | |
|---|---|
| f1 | 6.9603917 |
| f2 | −21.55524 |
| f3 | 12.092664 |
| f4 | −26.96464 |
| f5 | −67.61103 |
| f6 | 8.9355683 |
| f7 | −4.491803 |
| f1/f | 1.1887759 |
| f2/f | −3.681452 |
| f3/f | 2.0653245 |
| f4/f | −4.605331 |
| f5/f | −11.54739 |
| f6/f | 1.5261193 |
| f7/f | −0.767162 |
| L1/L2 | 1.302 |
| L1/IH | 0.2983597 |

Table 20 illustrates an inflection point of the imaging lens system 100d illustrated in FIG. 5.

TABLE 20

| | |
|---|---|
| S1 | 1 |
| S2 | 1 |
| S3 | 2 |
| S4 | 1 |
| S5 | 0 |
| S6 | 1 |
| S7 | 0 |
| S8 | 3 |
| S9 | 3 |
| S10 | 5 |
| S11 | 3 |
| S12 | 3 |
| S13 | 2 |
| S14 | 5 |

As described above, technical features of the imaging lens system illustrated in FIGS. 2 to 5 are summarized as in the table below. Table 21 illustrates characteristics of an imaging lens system according to an embodiment.

TABLE 21

| No. | Feature | 100a(FIG. 2) | 100b(FIG. 3) | 100c(FIG. 4) | 100d (FIG. 5) |
|---|---|---|---|---|---|
| 1 | TTL/(IH*2) < 56% | 55.20% | 54.60% | 53.90% | 55.50% |
| 2 | CRA > 40 | 44.4 | 44.4 | 42.2 | 45.3 |
| 3 | 40 < HFOV < 50 | 46.5 | 46.3 | 46.1 | 45.6 |
| 4 | 0.25 < L1 Aperture/(IH) < 0.3 | 0.274 | 0.27 | 0.282 | 0.298 |
| 5 | 0.7 < FBL < 0.9 | 0.75 | 0.75 | 0.85 | 0.75 |
| 6 | 1.15 < TTL/EFL < 1.2 | 1.16 | 1.18 | 1.17 | 1.14 |
| 7 | 0.45 > \| Max Sag*/Aperture \| > 0.25 | 0.36/0.25 | 0.31/0.30 | 0.41/0.39 | 0.38/0.35 |
| 8 | Edges of Lenses being convex toward | ◯ | ◯ | ◯ | ◯ |
| | Object Side, except for L1 to L3 | | | | |
| 9 | 1.25 < L1 Aperture/L2 Aperture < 1.35 | 1.302 | 1.251 | 1.206 | 1.275 |

In this case, the IH stands for an image height and is a half diagonal diameter of an image sensor, the HFOV stands for a half field of view and is half an angle of view of the image sensor, the Aperture is a size of a diameter (an effective diameter) in a lens through which light passes, and the Sag is an Y coordinate relative to a center.

The present inventive concept may be applicable to an electronic device having a camera implemented with the lens assembly described above.

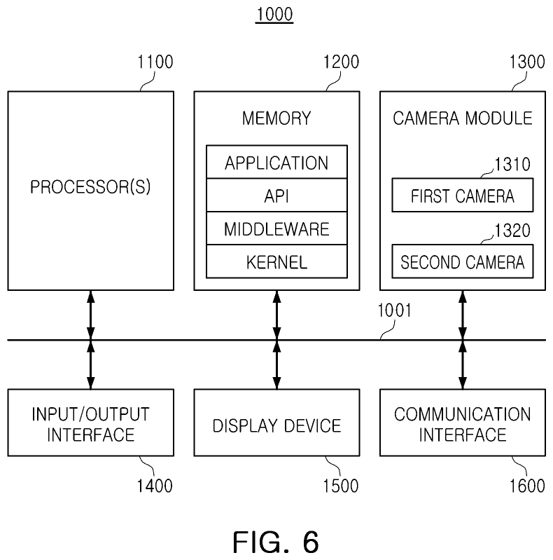

FIG. 6 is a view illustrating an electronic device 1000 according to an embodiment. Referring to FIG. 6, an electronic device 1000 may include at least one processor 1100 connected to a bus 1001, a memory 1200, a camera module 1300, an input/output interface device 1400, a display device 1500, and a communication interface 1600.

The processor 1100 may include a central processing unit (CPU), an application processor (AP), or a communication processor (CP). The processor 1100 may, for example, execute calculations or data processing related to control and/or communication of at least one other component of the electronic device 1000. In an embodiment, the processor 1100 may operate as an image processing unit (ISP) for processing image data collected through a first camera 1310 and a second camera 1320. For example, the processor 1100 may combine or correct the image data respectively collected through the first camera 1310 and the second camera 1320. The processor 1100 may execute a digital image stabilization module (i.e., may execute image stabilization software code) for stabilizing a main image for a moving subject. The digital image stabilization module may acquire motion information from the first camera 1310, may control the prism of the second camera 1320 based on the acquired motion information, may acquire surrounding image information from the second camera 1320, and, stabilization of the main image related to the moving subject may be achieved using the acquired surrounding image information.

According to an embodiment, the processor 1100 may generate a control signal for moving or rotating a reflector (a prism, or a driver mounted on the reflector) in the second camera 1320. The processor 1100 may move or rotate the reflector, such that a field of view (FOV) of the second camera 1320 at a point at which the subject is placed is included in a field of view of the first camera 1310 or is brought into contact in the field of view of the first camera 1310.

The memory 1200 may include a volatile memory or a non-volatile memory. The memory 1200 may store, for example, a command or data related to at least one other component of the electronic device 1000.

In an embodiment, the memory 1200 may store a software or a program. The program may include, for example, a kernel, a middleware, an application programming interface (API), or an application program. At least portion of the kernel, the middleware, or the API may be referred to as an operating system. The kernel may, for example, control or manage a system resource (e.g., the bus 1001, the processor 1100, or the memory 1200) used in executing an operation or a function implemented in other programs (e.g., the middleware, the API, or the application program).

Also, the kernel may provide an interface capable of controlling or managing the system resource by accessing individual components of the electronic device 1000 through the middleware, the API, or the application program. The middleware, for example, may perform an intermediary role, such that the API or the application program communicates with the kernel to exchange data. Also, the middleware may process task requests received from the application program according to priority. For example, the middleware may give at least one of the application programs a priority for using the system resource (e.g., the bus 1001, the processor 1100, or the memory 1200) of the electronic device 1000, and the task requests may be processed. The API may be an interface for the application program to control a function provided by the kernel or the middleware, and may include, for example, at least one interface or function (e.g., command) for file controlling, window controlling, image processing, character controlling, or the like.

The camera module 1300 may be implemented to acquire a photo or a video. The camera module 1300 may include a first camera 1310 and a second camera 1320. Although the camera module 1300 illustrated in FIG. 6 is illustrated as having the two cameras 1310 and 1320, it should be understood that the number of cameras of the present inventive concept is not limited thereto. In an embodiment, the first camera 1310 and the second camera 1320 may be disposed in the same direction, or may be disposed apart from each other by a specified distance. For example, the first camera 1310 and the second camera 1320 may be rear cameras disposed to face a rear surface of the electronic device 1000 (a surface opposite to a surface toward which the display device 1500 faces). At least one of the first camera 1310 or the second camera 1320 may be implemented with the lens assembly described in FIGS. 1 to 5.

The first camera 1310 may be equipped with a wide-angle lens having a relatively wide field of view (a wide-angle) and suitable for capturing an image of a subject at a short distance. In an embodiment, the first camera 1310 may be fixed to the electronic device 1000, and an image of a subject may be captured in a specific direction by the electronic device 1000. The second camera 1320 may be equipped with a telephoto lens having a relatively narrow field of view (FOV) and suitable for capturing an image of a subject at a long distance. In an embodiment, the second camera 1320 may capture an image of a subject in various directions by moving a prism in an upward, downward, left, or right direction. In this case, the prism may be controlled by the digital image stabilization module executed in the processor 1100. For example, by controlling the prism according to control of the digital image stabilization module, the second camera 1320 may acquire surrounding image information on a rapidly moving subject.

The input/output interface device 1400 may transmit, for example, a command or data input from a user or an external device to other component(s) of the electronic device 1000, or may output a command or data received from other component(s) of the electronic device 1000 to the user or the external device.

The display device 1500 may include, for example, a liquid crystal display (LCD), a light emitting diode (LED) display, an organic light emitting diode (OLED) display, or a microelectromechanical system (MEMS) display, or an electronic paper display. For example, the display device 1500 may display various contents (e.g., a text, an image, a video, an icon, or a symbol) to the user. The display device 1500 may include a touch screen. The display device 1500 may receive, for example, a touch input, a gesture input, an approach input, or a hovering input using an electronic pen or a portion of the user's body.

The communication interface 1600 may establish communication between the electronic device 1000 and an external device (e.g., an external electronic device or a server). For example, the communication interface 1600 may be connected to a network through wireless or wired communication, to communicate with an external device.

Although not illustrated, the electronic device 1000 may include various types of sensors. In particular, the electronic device 1000 may include an acceleration sensor (e.g., a gyro sensor) for acquiring location information.

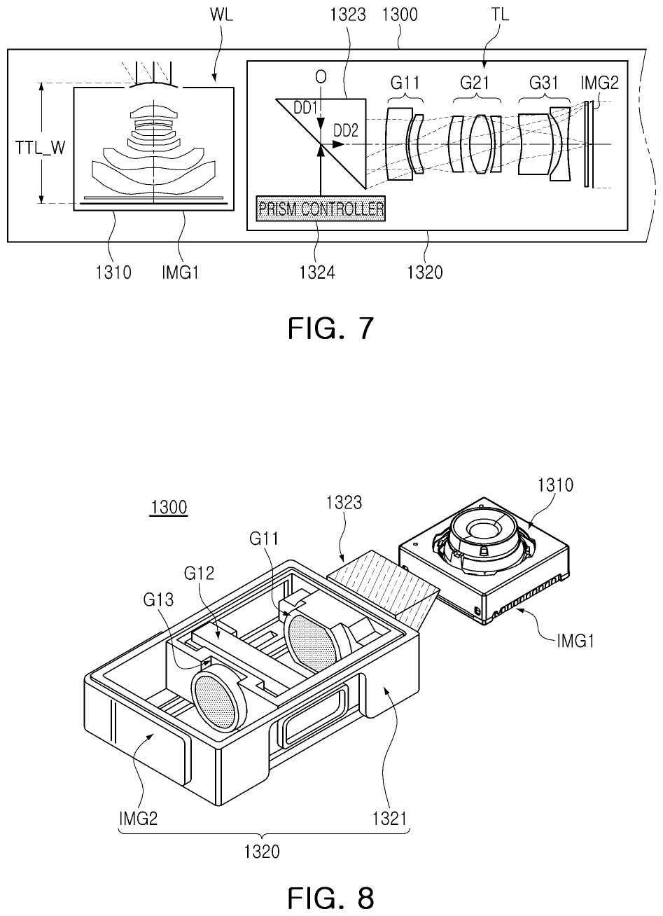

FIG. 7 is a view illustrating a camera module 1300 according to an embodiment. Referring to FIG. 7, a camera module 1300 may include a first camera 1310 and a second camera 1320. The camera module 1300 including a first optical lens assembly WL having a first angle of view and a second optical lens assembly TL having a second angle of view is illustrated. In an embodiment, a second angle of view may be narrower than a first angle of view. In this case, an image of the second angle of view may be an image corresponding to a region actually recorded. The first optical lens assembly WL may be, for example, a wide-angle single vision lens assembly. The second optical lens assembly TL may be a zoom lens assembly.

The first camera 1310 may include a first image sensor IMG1 capable of acquiring an image signal using light passing through the first optical lens assembly WL. In an embodiment, the first optical lens assembly WL of the first camera 1310 may be implemented as the lens assembly described in FIGS. 1 to 5.

The second camera 1320 may include a second image sensor IMG2 capable of acquiring an image signal using light passing through the second optical lens assembly TL. In an embodiment, the first optical lens assembly WL may have a zoom magnification of a first section according to the first angle of view, and the second optical lens assembly TL may have a zoom magnification of a second section according to the second angle of view. A processor 1100 (see FIG. 1) may capture an image of a subject using at least one of the first image sensor IMG1 or the second image sensor IMG2, and, when an image is captured according to the zoom magnification of the second section, a second lens group G21 and a third lens group G31 may be moved. For example, the zoom magnification of the first section may have a range of 1 to 1.9 times, and the zoom magnification of the second section may have a range of 2 to 3 times.

It should be understood that lens configurations of the first optical lens assembly WL and the second optical lens assembly TL are illustrative.

The second camera 1320 may include a second image sensor IMG2, a second optical lens assembly TL, a prism 1323, and a prism controller 1324. In the second camera 1320, an optical axis direction may be converted from a first direction DD1 to a second direction DD2 by the prism 1323 (a reflective member). Lenses of the first optical lens assembly WL may be arranged in a direction, parallel to the first direction DD1, for example. For example, the first direction DD1 may be parallel to a thickness direction of an electronic device 1000 (FIG. 1), and the second direction DD2 may be perpendicular to the thickness direction. TTL W illustrated in FIG. 7 represents a total length of the first optical lens assembly WL, and the total length represents a distance from an object side surface of a lens, closest to an object side, to the first image sensor IMG1, along an optical axis.

The prism controller 1324 may control a driving direction of the prism 1323 according to control (i.e., under the control) of the processor 1100. In particular, the prism controller 1324 may control driving of the prism 1323, based on a control command according to execution of a digital image stabilization module of the processor 1100.

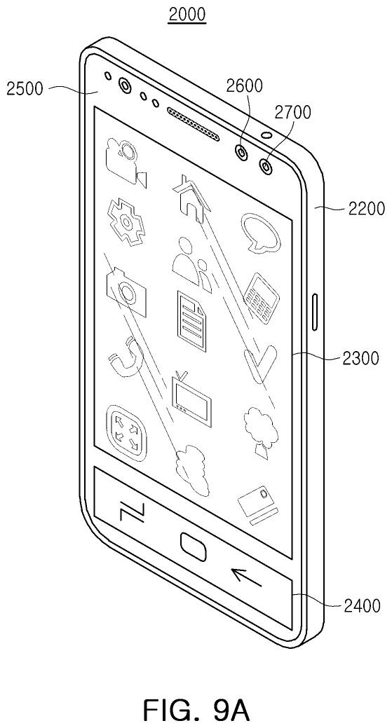

FIG. 8 is a view illustrating a configuration of a camera module 1300 according to an embodiment. Referring to FIG. 8, a second camera 1320 may change a driving direction of a prism 1323 attached to a housing 1321. Also, the second camera 1320 may move lens groups G12 and G13 to adjust a zoom magnification.

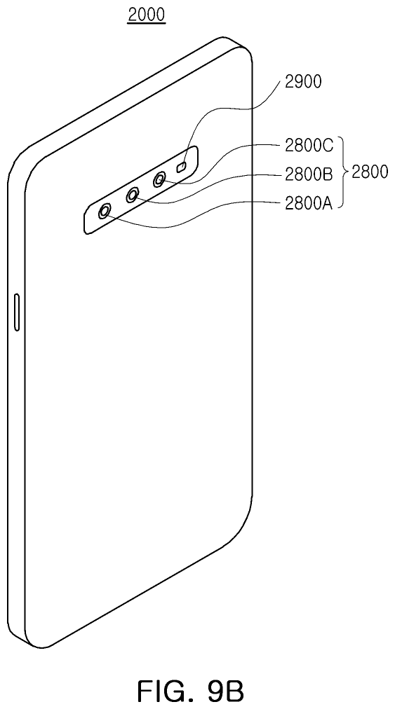

FIGS. 9A and 9B are views illustrating a mobile device 2000 according to an embodiment. Referring to FIGS. 9A and 9B, a mobile device 2000 may include a housing 2200, a display device 2500, and cameras 2600, 2700, and 2800.

In an embodiment, the display 2500 may cover substantially an entire front surface of the housing 2200, and a first region 2300 and a second region 2400 may operate according to an operating mode of the mobile device 2000 or an application, which is being executed.

Referring to FIG. 9A, front cameras 2600 and 2700 may include a first front camera 2600 and a second front camera 2700, having different characteristics. For example, the first front camera 2600 and the second front camera 2700 may have different aperture values, different focal lengths, different angles of view, or the like. In this case, the first front camera 2600 may be a general camera, and the second front camera 2700 may be a time-of-flight (ToF) camera. When the second front camera 2700 is a ToF camera, the second front camera 2700 may be combined with a separate light source to provide a function of distance measurement, a function of depth map generation, and a function of face recognition.

Referring to FIG. 9B illustrating a rear surface of the mobile device 2000, the mobile device 2000 may include a rear camera 2800 and a light emitting unit 2900. Like the front cameras 2600 and 2700, the rear camera 2800 may include a plurality of rear cameras 2800A, 2800B, and 2800C that differ in at least one of an aperture value, an angle of view, or the number of pixels of an image sensor. The light emitting unit 2900 may employ an LED or the like as a light source, and may operate as a flash in an application using the rear camera 2800. At least one of the plurality of cameras 2600, 2700, and 2800 may include a lens, an image sensor, a motor unit, or an engine unit. At least one of the plurality of rear cameras 2800A, 2800B, and 2800C may perform a function of the above-described first camera, and the other may perform a function of the above-described second camera.

The image sensor may provide RGB data based on the clock signal. For example, the image sensor may interface with the engine unit through a mobile industry processor interface (MIPI) or a camera serial interface (CSI). The motor unit may adjust focusing of a lens or perform shuttering in response to a control signal received from the engine unit. The engine unit may control the image sensor and the motor unit. In addition, the engine unit may generate YUV data (YUV) including a luminance component, a difference between a luminance component and a blue component, and a difference between a luminance component and a red component, based on the RGB data received from the image sensor, or may generate compressed data, for example, joint photography experts group (JPEG) data. The engine unit may be connected to a host/application, and the engine unit may provide the YUV data (YUV) or the JPEG data to the host/application, based on a master clock. In addition, the engine unit may interface with the host/application through a serial peripheral interface (SPI) or an inter integrated circuit (I2C).

The present inventive concept may disclose an optical imaging system capable of improving performance of a small camera without increasing a size of the small camera. The optical imaging system of the present inventive concept may include 7 to 8 plastic lenses, and may have an effect of reducing the size without impairing the performance of the small camera. An optical imaging system according to an embodiment may be implemented to satisfy TTL/IH<1.12 and CRA>40 conditions.

In general, as performance of a small camera is advanced in a wireless terminal, there is a trend to mount a larger sensor. However, as such a larger sensor is installed, a TTL of a lens may increase, which has a side effect of deteriorating aesthetics of a design. To improve this, development of a lower TTL lens is required. The present inventive concept may minimize the TTL by increasing a CRA to 45 degrees.

An imaging lens system and an electronic device having the same according to an embodiment may appropriately adjust a lens length (TTL; a total top length) and an image height (IH), to improve performance of a camera while reducing a size thereof.

An imaging lens system and an electronic device having the same according to an embodiment may minimize relative illumination (RI) while minimizing TTL, and may secure a flange back length (FBL) as much as possible.

An imaging lens system and an electronic device having the same according to an embodiment may form a chief ray angle (CRA) at 45°, to have TTL having 55% relative to a diagonal length of a sensor.

An imaging lens system and an electronic device having the same according to an embodiment may minimize a change in camera module process.

While example embodiments have been illustrated and described above, it will be apparent to those skilled in the art that modifications and variations could be made without departing from the scope of the present inventive concept as defined by the appended claims.

What is claimed is:

1. An imaging lens system comprising:
a first lens, a second lens, a third lens, a fourth lens, a fifth lens, a sixth lens, and a seventh lens, sequentially arranged from an object side of the imaging lens system to an image side of the imaging lens system,
wherein a lens length (TTL) of the imaging lens system is a distance from an incident surface of the first lens to an imaging plane on the image side of the imaging lens system,
wherein an image height (IH) is a diagonal diameter of an image sensor at the imaging plane on the image side of the imaging lens system, and
wherein the lens length (TTL) divided by twice the image height (IH) is less than 0.56.

2. The imaging lens system of claim 1, wherein each of the first to seventh lenses comprises plastic material, and
has an aspherical surface.

3. The imaging lens system of claim 1, wherein a chief ray angle (CRA) of the image sensor is greater than 40°.

4. The imaging lens system of claim 1, wherein a half field of view (HFOV) of the image sensor is greater than 40 and less than 50.

5. The imaging lens system of claim 1, wherein a size of an aperture through which light is incident on the first lens divided by the image height (IH) is greater than 0.25 and less than 0.3.

6. The imaging lens system of claim 1, wherein a flange back length (FBL) is a distance from the image sensor to a lens mount and is greater than 0.7 mm and less than 0.9 mm.

7. The imaging lens system of claim 1, wherein the lens length (TTL) divided by an effective focal length (EFL) is greater than 1.15 and less than 1.2.

8. The imaging lens system of claim 1, wherein an absolute value of a maximum height value (Max Sag) from an arbitrary point on an aspherical surface of the seventh lens in an optical axis direction to an apex of the aspherical surface, divided by a size of an effective diameter of the seventh lens, is greater than 0.25 and less than 0.45.

9. The imaging lens system of claim 1, wherein an edge of an object side surface of the fourth lens is convex,
wherein an edge of an object side surface of the fifth lens is convex,
wherein an edge of an object side surface of the sixth lens is convex, and
wherein an edge of an object side surface of the seventh lens is convex.

10. The imaging lens system of claim 1, wherein a size of an effective diameter of the first lens divided by a size of an effective diameter of the second lens is greater than 1.25 and less than 1.35.

11. An imaging lens system comprising:
a first lens comprising a convex object side surface, and having positive refractive power;
a second lens on an image side of the first lens, the second lens comprising a concave image side surface, and having negative refractive power;
a third lens on an image side of the second lens, the third lens comprising a convex object side surface, and having positive refractive power;
a fourth lens on an image side of the third lens, the fourth lens comprising a concave object side surface, and having negative refractive power;
a fifth lens on an image side of the fourth lens, the fifth lens comprising a concave object side surface, and having negative refractive power;
a sixth lens on an image side of the fifth lens, the sixth lens comprising a concave object side surface, and having negative refractive power;
a seventh lens on an image side of the sixth lens, the seventh lens comprising a concave object side surface, having positive refractive power, and wherein the object side surface of the seventh lens and an image side surface of the seventh lens each have at least two inflection points;
an eighth lens on an image side of the seventh lens, the eighth lens comprising a concave object side surface, and having negative refractive power; and
a filter on an image side of the eighth lens,
wherein a lens length (TTL) of the imaging lens system is a distance from an incident surface of the first lens to an imaging plane on the image side of the eighth lens, and
wherein an image height (IH) is a diagonal diameter of an image sensor at the imaging plane on the image side of the eighth lens, and
wherein the lens length (TTL) divided by twice the image height (IH) is less than 0.56.

12. The imaging lens system of claim 11, wherein the second lens has a refractive index of 1.64 or more.

13. The imaging lens system of claim 11, wherein a chief ray angle (CRA) of the image sensor is greater than 40°, and
wherein a half field of view (HFOV) of the image sensor is greater than 40 and less than 50.

14. The imaging lens system of claim 11, wherein an edge of an object side surface of the fourth lens is convex,
wherein an edge of an object side surface of the fifth lens is convex,
wherein an edge of an object side surface of the sixth lens is convex,
wherein an edge of an object side surface of the seventh lens is convex, and
wherein an edge of an object side surface of the eighth lens is convex.

15. The imaging lens system of claim 11, wherein an absolute value of a maximum height value (Max Sag) from an arbitrary point on an aspherical surface of the eighth lens in an optical axis direction to an apex of the aspherical surface, divided by a size of an effective diameter of the eighth lens, is greater than 0.25 and less than 0.45.

16. An electronic device comprising:
a camera module comprising a first camera configured to capture a first image, the first camera comprising a first angle of view, and a second camera configured to capture a second image, the second camera comprising a second angle of view, narrower than the first angle of view;
a memory device configured to store software code related to a digital image stabilization module;
a display device configured to display the second image captured by the second camera;
an input/output interface device configured to input/output data with an input/output device;
a communication interface device configured to communicate with an external device; and
at least one processor configured to control the camera module, the memory device, the display device, the input/output interface device, and the communication interface device, and to execute the software code,
wherein at least one of the first camera and the second camera includes an imaging lens system comprising 7 or 8 lenses sequentially arranged from an object side of the imaging lens system to an image side of the imaging lens system,
wherein a lens length (TTL) of the imaging lens system is a distance from an incident surface of a first lens in the imaging lens system to an imaging plane on the image side of the imaging lens system, and
wherein an image height (IH) is a diagonal diameter of an image sensor at the imaging plane on the image side of the imaging lens system, and
wherein the lens length (TTL) divided by twice the image height (IH) is less than 0.56.

17. The electronic device of claim 16, wherein a refractive index of a second lens in the imaging lens system that is adjacent to the first lens is 1.64 or more.

18. The electronic device of claim 16, wherein both surfaces of a lens adjacent to a last one of the lenses in the imaging lens system have at least two inflection points.

19. The electronic device of claim 16, wherein, on both sides of the first lens in the imaging lens system, an absolute value of a maximum height value (Max Sag) from an arbitrary point on an aspherical surface of the first lens in an optical axis direction to an apex of the aspherical surface, divided by a size of an effective diameter of the first lens, is greater than 0.25 and less than 0.45.

20. The electronic device of claim 16, wherein a chief ray angle (CRA) of the image sensor is greater than 40°,
wherein a half field of view (HFOV) of the image sensor is greater than 40 and less than 50, and
wherein a flange back length (FBL) is a distance from the image sensor to a lens mount and is greater than 0.7 mm and less than 0.9 mm.
